(19) United States
(12) Patent Application Publication
(10) Pub. No.: US 2026/0214373 A1
(43) Pub. Date: Jul. 23, 2026

(54) HOUSINGS AND EARPHONES

(71) Applicant: SHOKZ GLOBAL LIMITED, Hong Kong (HK)

(72) Inventors: Qi SU, Shenzhen (CN); Fengyun LIAO, Shenzhen (CN); Xin QI, Shenzhen (CN)

(73) Assignee: SHOKZ GLOBAL LIMITED, Hong Kong (HK)

(21) Appl. No.: 19/571,439

(22) Filed: Mar. 18, 2026

Related U.S. Application Data
(63) Continuation of application No. PCT/CN2024/103704, filed on Jul. 4, 2024.

(51) Int. Cl. H04R 1/10

(52) U.S. Cl. CPC H04R 1/1058; H04R 1/1016; H04R 1/105

(57) ABSTRACT

The present disclosure relates to a housing. The housing includes an inner housing and a silicone coating layer. The silicone coating layer is disposed on at least a portion of an outer surface of the inner housing, the silicone coating layer includes a first silicone coating layer and a second silicone coating layer sequentially stacked on the outer surface of the inner housing, the first silicone coating layer is bonded to the outer surface of the inner housing, the second silicone coating layer covers a side of the first silicone coating layer away from the inner housing, a hardness of the second silicone coating layer is greater than a hardness of the first silicone coating layer, a compressive modulus of the first silicone coating layer is within a range of 0.01 MPa to 0.1 MPa; and a bonding strength between the first silicone coating layer and the inner housing is not less than 0.005 MPa.

### CROSS-REFERENCE TO RELATED APPLICATIONS

This application is a Continuation of International Application No. PCT/CN2024/103704 filed on Jul. 4, 2024, the entire contents of which are incorporated herein by reference.

### TECHNICAL FIELD

The present disclosure relates to the technical field of electronic devices, and in particular, to housings and earphones.

### BACKGROUND

An earphone may be worn by a user to listen to sound. When the user contacts the earphone, the user contacts a housing of the earphone. When the housing is relatively hard, the wearing comfort experienced by the user would be reduced.

### SUMMARY

The present disclosure provides a housing. The housing includes an inner housing and a silicone coating layer. The silicone coating layer is disposed on at least a portion of an outer surface of the inner housing. The silicone coating layer includes a first silicone coating layer and a second silicone coating layer sequentially stacked on the outer surface of the inner housing. The first silicone coating layer is bonded to the outer surface of the inner housing. The second silicone coating layer covers a side of the first silicone coating layer away from the inner housing. A hardness of the second silicone coating layer is greater than a hardness of the first silicone coating layer. A compressive modulus of the first silicone coating layer is within a range of 0.01 megapascal (MPa) to 0.1 MPa. A bonding strength between the first silicone coating layer and the inner housing is not less than 0.005 MPa.

The present disclosure provides an earphone. The earphone includes an ear hook and the housing described above. The housing has a connecting end connected to the ear hook and a free end not connected to the ear hook. The silicone coating layer is disposed on at least a portion of the free end.

In the present disclosure, the second silicone coating layer covers the side of the first silicone coating layer away from the inner housing to protect the first silicone coating layer. When the compressive modulus of the first silicone coating layer is 0.01-0.1 MPa, the silicone coating layer can be relatively soft. When the housing contacts a user through the silicone coating layer, the wearing comfort of the user can be improved.

### BRIEF DESCRIPTION OF THE DRAWINGS

In order to more clearly illustrate the technical solutions in the embodiments of the present disclosure, the accompanying drawings that need to be used in the description of the embodiments will be briefly introduced in the following. Obviously, the drawings in the following description are only some of the embodiments of the present disclosure, and for a person skilled in the art, other drawings can be obtained according to these drawings without creative labor.

FIG. 1 is a schematic diagram illustrating an exemplary structure of a housing according to some embodiments of the present disclosure;

FIG. 2 is a schematic diagram illustrating an exemplary structure of a portion M of the housing in FIG. 1 according to some embodiments of the present disclosure;

FIG. 3 is a schematic diagram illustrating an exemplary internal structure of a first silicone coating layer shown in FIG. 1 according to some embodiments of the present disclosure;

FIG. 4 is a schematic diagram illustrating an exemplary internal structure of a first silicone coating layer shown in FIG. 1 according to some embodiments of the present disclosure;

FIG. 5 is a schematic diagram illustrating an exemplary anterior side profile of an ear of a user or a simulator according to some embodiments of the present disclosure;

FIG. 6 is a schematic diagram illustrating an exemplary earphone according to some embodiments of the present disclosure;

FIG. 7 is a schematic diagram illustrating the earphone shown in FIG. 6 in a wearing state according to some embodiments of the present disclosure;

FIG. 8 is a schematic diagram illustrating a structure of the earphone shown in FIG. 6 from another perspective according to some embodiments of the present disclosure;

FIG. 9 is a schematic diagram illustrating a structure of the earphone shown in FIG. 6 from still another perspective according to some embodiments of the present disclosure;

FIG. 10 is a schematic diagram illustrating a cross-sectional view of the earphone in FIG. 6 along a line X-X according to some embodiments of the present disclosure; and

FIG. 11 is a schematic diagram illustrating a cross-sectional view of an ear hook in FIG. 6 along a line XI-XI according to some embodiments of the present disclosure.

### DETAILED DESCRIPTION

The following will clearly and completely describe the technical solutions in the embodiments of the present disclosure with reference to the accompanying drawings in the embodiments of the present disclosure. Obviously, the described embodiments are only a part of the embodiments of the present disclosure, and not all of them. Based on the embodiments of the present disclosure, all other embodiments obtained by persons of ordinary skill in the art without making creative efforts belong to the scope of protection of the present disclosure.

In the present disclosure, a term “embodiment” means that a specific feature, structure, or characteristic described in connection with the embodiment may be included in at least one embodiment of the present disclosure. The persons of ordinary skill in the art explicitly and implicitly understand that the embodiments described in the present disclosure can be combined with other embodiments.

A housing is described below. The housing may serve as an external housing of an electronic device or other product. The housing may at least protect an internal structure of the electronic device or the other product. The housing may also provide a comfortable tactile sensation to a user through an external layer at least a portion of which is soft. The housing may also improve the wearing comfort of the user when the user wears the electronic device or the other product.

The housing may carry and mount various electronic components to form the electronic device. As used herein, an “electronic device” (also referred to as a “terminal,” a “mobile terminal,” or an “electronic apparatus”) includes, but is not limited to, a cellular phone, an audio player, a medical device, an augmented reality (AR)/virtual reality (VR) device, etc.

An earphone is taken as an example for describing the electronic device in the present disclosure. This does not affect the replacement of the earphone with another electronic device or product, and the use of the embodiment of the housing.

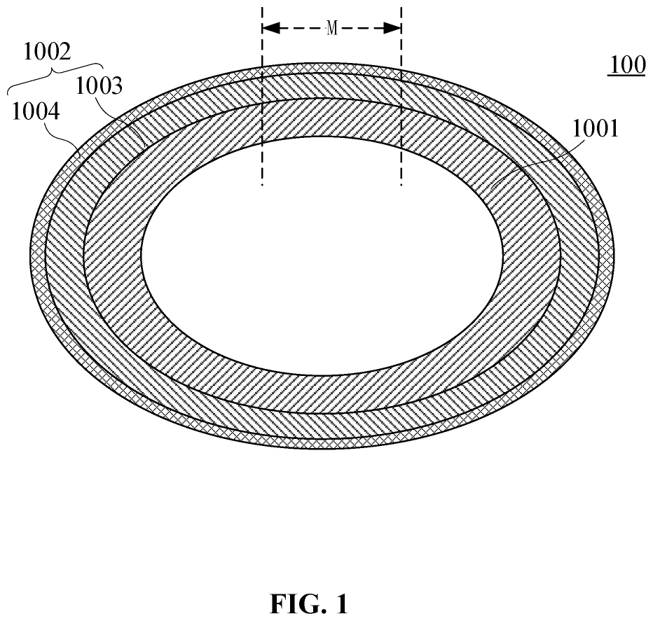

Referring to FIG. 1, FIG. 1 is a schematic diagram illustrating an exemplary structure of a housing 100 according to some embodiments of the present disclosure. The housing 100 may include an inner housing 1001 and a silicone coating layer 1002. The inner housing 1001 may serve as a main carrier for mounting electronic components or other structures in an electronic device or other product. The silicone coating layer 1002 may be disposed on at least a portion of an outer surface of the inner housing 1001 to form an external layer of the housing 100. A comfortable tactile sensation is provided to a user through a soft characteristic of the silicone coating layer 1002. When the user wears the housing 100, a wearing comfort of the user can be improved through the silicone coating layer 1002.

In some embodiments, the silicone coating layer 1002 may be disposed on an entire outer surface of the inner housing 1001. This can improve the overall tactile comfort of the housing 100, and provide the user with a different visual perception. In some embodiments, the silicone coating layer 1002 may be disposed on a portion of the outer surface of the inner housing 1001. An appearance expressiveness of the housing 100 can be improved through a combination of different structures.

The silicone coating layer 1002 may include a first silicone coating layer 1003 and a second silicone coating layer 1004 sequentially stacked on the outer surface of the inner housing 1001. The first silicone coating layer 1003 is bonded to the outer surface of the inner housing 1001. The second silicone coating layer 1004 covers a side of the first silicone coating layer 1003 away from the inner housing 1001. The first silicone coating layer 1003 serves as a main stack layer that provides the housing 100 with the soft characteristic, and is configured to improve the wearing comfort of the housing 100. The second silicone coating layer 1004 is at least configured to protect the first silicone coating layer 1003 and protect the inner housing 1001. In some embodiments, the second silicone coating layer 1004 can have a poorer soft characteristic than the first silicone coating layer 1003, to highlight a protective effect of the second silicone coating layer 1004 on the first silicone coating layer 1003.

A hardness of the first silicone coating layer 1003 may be less than a hardness of the inner housing 1001, and may also be less than a hardness of the second silicone coating layer 1004, such that the first silicone coating layer 1003 serves as the main stack layer for improving the wearing comfort of the housing 100. In some embodiments, a compressive modulus of the first silicone coating layer 1003 may be within a range of 0.01 megapascal (MPa) to 0.1 MPa. The soft characteristic of the first silicone coating layer 1003 is characterized by limiting the compressive modulus. When the compressive modulus of the first silicone coating layer 1003 is lower than 0.01 MPa, a liquid silicone raw material becomes too soft to process the silicone coating layer 1002. When the compressive modulus of the first silicone coating layer 1003 is higher than 0.1 MPa, the soft characteristic of the silicone coating layer 1002 can be reduced, and the wearing comfort of the user can also be reduced.

By limiting the compressive modulus within the range of 0.01 MPa to 0.1 MPa, the first silicone coating layer 1003 can be softer. Under a requirement of the same soft characteristic, the silicone coating layer 1002 can be thinner. Further, under a requirement of the housing 100 of the same size, a volume of the inner housing 1001 can be increased as much as possible. Moreover, under a requirement of the housing 100 of the same structure, the volume of the housing 100 can be reduced as much as possible.

In some embodiments, the compressive modulus of the first silicone coating layer 1003 may be within a range of 0.01 MPa to 0.06 MPa, so as to improve the soft characteristic of the first silicone coating layer 1003 and also provide shock absorption. Then, the first silicone coating layer 1003 can restore its original shape after compression ends, thereby reducing an accumulation of permanent deformation and improving a service life of the silicone coating layer 1002. When the electronic device or other products fall off, the first silicone coating layer 1003 can provide the shock absorption and protect the electronic device or other products. When the electronic device is an earphone, the earphone can contact with the user through the first silicone coating layer 1003. The first silicone coating layer 1003 can absorb the vibration of the earphone and alleviate the user's tingling sensation caused by the vibration of the earphone.

In some embodiments, the compressive modulus of the first silicone coating layer 1003 is within a range of 0.01 MPa to 0.04 MPa, so as to make the first silicone coating layer 1003 thinner while having the relatively good soft characteristic.

In some embodiments, the compressive modulus of the first silicone coating layer 1003 may be a compressive modulus value, such as, 0.02 MPa, 0.03 MPa, 0.04 MPa, 0.05 MPa, 0.06 MPa, 0.07 MPa, 0.08 MPa, 0.09 MPa, etc.

The first silicone coating layer 1003 may be bonded to the inner housing 1001 through bonding. A bonding strength between the first silicone coating layer 1003 and the inner housing 1001 is not less than 0.005 MPa. For example, the bonding strength between the first silicone coating layer 1003 and the inner housing 1001 is not less than 0.01 MPa.

Since the first silicone coating layer 1003 has the relatively good soft characteristic, the first silicone coating layer 1003 is relatively difficult to be disposed on the inner housing 1001. By limiting the bonding strength to not less than 0.01 MPa, connection stability between the first silicone coating layer 1003 and the inner housing 1001 can be improved when the first silicone coating layer 1003 has the relatively good soft characteristic, thereby reducing difficulty in disposing the first silicone coating layer 1003 on the inner housing 1001. In addition, it is easy for the first silicone coating layer 1003 to peel off or detach from the inner housing 1001 during the use of the housing 100. Therefore, when the bonding strength is not less than 0.005 MPa, the connection stability between the first silicone coating layer 1003 and the inner housing 1001 can be improved.

In some embodiments, the bonding strength between the first silicone coating layer 1003 and the inner housing 1001 is not less than a bonding strength value, such as, 0.006 MPa, 0.008 MPa, 0.01 MPa, 0.016 MPa, 0.018 MPa, 0.02 MPa, 0.03 MPa, 0.04 MPa, 0.06 MPa, 0.1 MPa, 0.2 MPa, 0.4 MPa, 0.8 MPa, 1 MPa, 1.2 MPa, 1.4 MPa, 3 MPa, etc.

In some embodiments, the bonding strength between the first silicone coating layer 1003 and the inner housing 1001 may be controlled by repeatedly applying glue or using back-glue, so as to ensure the bonding strength between the first silicone coating layer 1003 and the inner housing 1001. The bonding strength may also be adjusted by selecting the glue. In addition, the bonding strength between the first silicone coating layer 1003 and the inner housing 1001 may be adjusted through technical solutions well known to those skilled in the art.

A thickness of the second silicone coating layer 1004 is less than a thickness of the first silicone coating layer 1003, such that the second silicone coating layer 1004 serves as the outer surface of the housing 100 to protect the first silicone coating layer 1003. By limiting the thickness of the second silicone coating layer 1004, an impact on the soft characteristic of the first silicone coating layer 1003 can be reduced, such that the external layer of the housing 100 has the soft characteristic. In addition, the protective effect of the second silicone coating layer 1004 on the first silicone coating layer 1003 can also be ensured. In some embodiments, the thickness of the second silicone coating layer 1004 is less than a thickness of the inner housing 1001.

The second silicone coating layer 1004 may be disposed on the first silicone coating layer 1003 through injection molding, and may also be bonded to the first silicone coating layer 1003 through bonding. In some embodiments, the first silicone coating layer 1003 between the second silicone coating layer 1004 and the inner housing 1001 may be omitted in a portion of a region of the inner housing 1001. The second silicone coating layer 1004 is directly connected to the inner housing 1001. For example, the second silicone coating layer 1004 may be disposed on the inner housing 1001 through injection molding, and may also be bonded to the inner housing 1001 through bonding.

The hardness of the second silicone coating layer 1004 is greater than the hardness of the first silicone coating layer 1003, allowing the first silicone coating layer 1003 to be sufficiently soft and the thickness of the second silicone coating layer 1004 to be relatively thin. In some embodiments, the hardness of the second silicone coating layer 1004 is less than a hardness of the inner housing 1001.

Referring to FIG. 1, the soft characteristic of the silicone coating layer 1002 is mainly provided by the first silicone coating layer 1003, such that the silicone coating layer 1002 is thinner through cooperation of the first silicone coating layer 1003 and the second silicone coating layer 1004. An overall thickness or a thickness of a portion of a region of the silicone coating layer 1002 may be within a range of 0.5 mm to 2.5 mm. In some embodiments, the overall thickness or the thickness of the portion of the region of the silicone coating layer 1002 may be a value, such as, 0.6 mm, 0.7 mm, 0.9 mm, 1.1 mm, 1.3 mm, 1.5 mm, 1.8 mm, 1.9 mm, 2 mm, 2.3 mm, etc.

Referring to FIG. 1., a preparation process of the first silicone coating layer 1003 may generally include following operations.

In operation 1, raw materials are prepared and mixed. Silicone rubber is used as a main raw material. A vulcanizing agent, a color paste (selected based on requirements), and other additives (e.g., a catalyst, a cross-linking agent, a filler, etc.) are added to the silicone rubber for mixing the raw materials. This operation may be performed in a rubber mixer, and various components (e.g., the raw materials) are uniformly distributed through mechanical stirring.

In operation 2, the mixed raw materials are compounded and plasticated. The mixed raw materials are placed in an open mill for compounding. Through extrusion by two large rollers, the mixed raw materials are transformed into a uniform pancake-like form. This operation can improve the plasticity and uniformity of the mixed raw materials. To achieve desired thickness and uniformity, multiple repetitions of compounding and adding the raw materials may be performed.

In operation 3, the color paste is added (operation 3 is selected based on the requirements). During the compounding operation, the color paste is cut into small pieces and added to the silicone rubber. The compounding operation is continued to achieve uniform color distribution.

In operation 4, the compounded raw materials are molded by extruding or hot pressing. The silicone rubber (or the compounded raw materials) may be formed by extrusion molding or hot pressing molding. The extrusion molding includes passing the compounded silicone rubber (or the compounded raw materials) through an extruder. Under high-temperature and pressure, the compounded silicone rubber is extruded through a mold to form a specific shape. The hot pressing molding includes placing the compounded silicone rubber (or the compounded raw materials) into a preset mold. The compounded silicone rubber is shaped under the high-temperature and pressure.

In operation 5, the molded silicone rubber (or the molded raw materials) is vulcanized. Regardless of whether the extrusion or hot pressing molding is used, a vulcanization treatment needs to be performed on the molded silicone rubber. This is a chemical cross-linking operation to enhance stability and physical properties of the molded raw materials. The vulcanization operation may be performed in an oven. The molded raw materials can be thoroughly cured by controlling time and temperature.

In operation 6: the vulcanized silicone rubber (or the vulcanized raw materials) is trimmed and processed. The vulcanized silicone product (i.e., the vulcanized silicone rubber) may require cutting, polishing, or other surface treatments to meet dimensional and appearance requirements of a final product.

In the preparation process, the hardness of the first silicone coating layer 1003 is effectively regulated including the following steps.

In step 1, the raw materials are adjusted. Different proportions of fillers, colorants, and additives are added to the raw materials.

In step 2, processing techniques are performed. By controlling factors (e.g., the temperature, the pressure, time, etc.) during the processing, the hardness of the silicone product is adjusted. Alternatively, processing techniques (e.g., staged vulcanization, pressurized vulcanization, etc.) may also be used to adjust the hardness of the silicone product.

In step 3, post-treatment techniques are performed. By employing post-treatment processes (e.g., surface treatment, heat treatment, etc.), the hardness of the silicone product may be adjusted.

In step 4, the hardness of the silicone product is adjusted by changing the length distribution of silane-based chains and using different platinum catalyst concentrations.

It may be understood that, the preparation process and hardness regulation of the first silicone coating layer 1003 may refer to the above embodiments. Of course, other technical solutions well-known to those skilled in the art may also be adopted, and are not limited to the embodiments listed herein. Furthermore, a preparation process and hardness regulation of the second silicone coating layer 1004 may also refer to the preparation process and the hardness regulation of the first silicone coating layer 1003, which is not repeated herein.

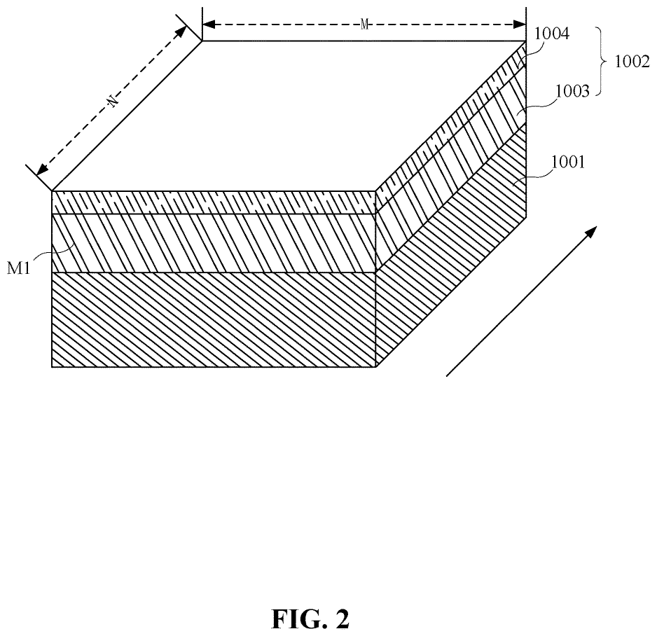

Referring to FIG. 1 and FIG. 2, FIG. 2 is a schematic diagram illustrating an exemplary structure of a portion M of the housing 100 in FIG. 1 according to some embodiments of the present disclosure. To determine the compressive modulus of the first silicone coating layer 1003, a portion M with a standard area of M×N may be obtained from the housing 100. Then, the portion M is measured. The standard area may be one of 1×1 mm², 2×2 mm², 3×3 mm², 4×3 mm², 3×3 mm², 4×4 mm², 5×2 mm², 5×5 mm², 1×1 cm², 2×2 cm², 1×3 cm², 3×3 cm², 3×3 cm², 2×4 cm², 4×4 cm², 5×5 cm², etc. Of course, the standard area may also be selected in other areas according to requirements.

At room temperature, an experimental instrument is used to extrude the portion M. The experimental instrument has an extrusion head capable of continuously applying a gradually increasing load to the extrusion head. A size and area of an extrusion plane of the extrusion head of the experimental instrument are larger than the standard area of the portion M. During the process of the extrusion head extruding the portion M, the gradually increasing load is applied to the extrusion head. Meanwhile, changes in the overall thickness of the portion M, changes in the overall thickness of the first silicone coating layer 1003, and the loads are recorded in real time.

A stress-strain curve is drawn by taking ratios of the loads to the standard area as pressure, as vertical coordinates, and percentages of the changes in the overall thickness of the first silicone coating 1003 to the initial thickness of the first silicone coating 1003 as a dependent variable, as horizontal coordinates.

In the stress-strain curve, since a portion of the stress-strain curve appears as a straight line, a slope of the straight-line portion of the stress-strain curve may serve as the compressive modulus of the first silicone coating layer 1003. In some embodiments, the strain amount corresponding to the straight-line portion of the stress-strain curve is within a range of 5% to10%. Accordingly, the compressive modulus of the first silicone coating layer 1003, measured when the first silicone coating layer 1003 is at the strain amount within the range of 5% to 10%, is within the range of 0.01 MPa to 0.1 MPa.

In some embodiments, the soft characteristic of the first silicone coating layer 1003 may cause the outer surface of the portion M to be compressed when subjected to a pressure of 0.5 MPa. The silicone coating layer 1002 may produce a compression amount within a range of 0.4 mm to 2 mm. When the silicone coating layer 1002 contacts with an irregular contact surface, the compression amount of 0.4 mm to 2 mm can make the silicone coating layer 1002 better adhere to the contact surface, thereby increasing the contact area, and improving the user's wearing comfort. In some embodiments, when the outer surface of the entire housing 100 or a portion of the housing 100 is compressed under the pressure of 0.5 MPa, the silicone coating layer 1002 may produce the compression amount in the range of 0.4 mm to 2 mm.

Referring to FIG. 1 and FIG. 2, to determine the bonding strength between the first silicone coating layer 1003 and the inner housing 1001, the portion M with the standard area may be obtained from the housing 100. At the room temperature, a peel test is performed on the portion M. The peel test may be performed using a universal testing machine, an electronic peel strength tester, a tensile testing machine, or a material testing machine equipped with a peel fixture. The inner housing 1001 of the portion M is stably fixed. The peel fixture is used to grip one edge of the silicone coating layer 1002 in the portion M (e.g., an edge M1 in FIG. 2), and grip the first silicone coating layer 1003 and the second silicone coating layer 1004. Then, a 90-degree peel or a 180-degree peel test is performed. A pulling force is gradually increased at a constant speed until the silicone coating layer 1002 begins to peel off from the inner housing 1001 (e.g., peeling the silicone coating layer 1002 from the inner housing 1001 along a direction indicated by an arrow in FIG. 2). A maximum pulling force value during the peeling process is recorded. A ratio of the maximum pulling force value to the standard area serves as the bonding strength between the first silicone coating layer 1003 and the inner housing 1001. Furthermore, when the bonding strength between the first silicone coating layer 1003 and the inner housing 1001 is determined, the silicone coating layer 1002 may be segmented on the housing 100 only according to the standard area, without cutting the inner housing 1001 from the housing 100. Then, the peel test peeling the silicone coating layer 1002 with the standard area is performed based on the peel test described above. The segmented silicone coating layer 1002 is peeled from the housing 100, and then the bonding strength between the first silicone coating layer 1003 and the inner housing 1001 is obtained.

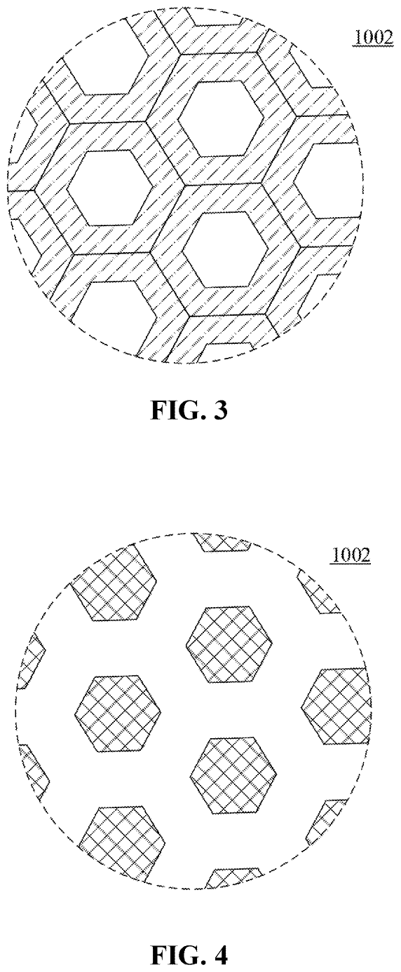

Referring to FIG. 3, FIG. 3 is a schematic diagram illustrating an exemplary internal structure of the first silicone coating layer 1003 shown in FIG. 1 according to some embodiments of the present disclosure. An interior of the first silicone coating layer 1003 may be a honeycomb structure, thereby enhancing the soft characteristic of the first silicone coating layer 1003 through an internal structure. Furthermore, on the basis of enhancing the soft characteristic of the first silicone coating layer 1003 through its internal structure, a difficulty of achieving the soft characteristic of the first silicone coating layer 1003 through the preparation process and the hardness regulation can be reduced.

Referring to FIG. 4, FIG. 4 is a schematic diagram illustrating an exemplary internal structure of the first silicone coating layer 1003 shown in FIG. 1 according to some embodiments of the present disclosure. An interior of the first silicone coating layer 1003 may be a column array structure, thereby enhancing the soft characteristic of the first silicone coating layer 1003 through an internal structure. Furthermore, on the basis of enhancing the soft characteristic of the first silicone coating layer 1003 through its internal structure, a difficulty of achieving the soft characteristic of the first silicone coating layer 1003 through the preparation process and the hardness regulation can be reduced.

Referring to FIG. 1, to improve and/or adjust the bonding strength between the first silicone coating layer 1003 and the inner housing 1001, a roughness of the outer surface of the inner housing 1001 may be defined. For example, a roughness of a bonding region of the outer surface of the inner housing 1001 for bonding the first silicone coating layer 1003 may be increased. In some embodiments, the roughness of the bonding region is within a range of 10 micrometers (μm) to 200 μm. In some embodiments, the roughness of the bonding region is greater than a roughness of at least a portion of other regions of the outer surface of the inner housing 1001.

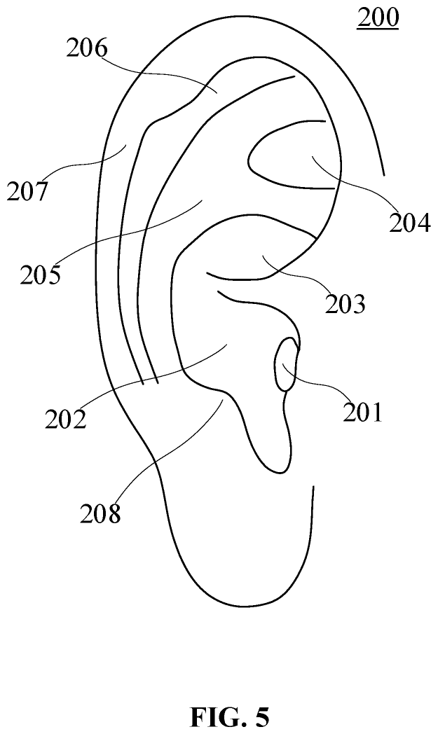

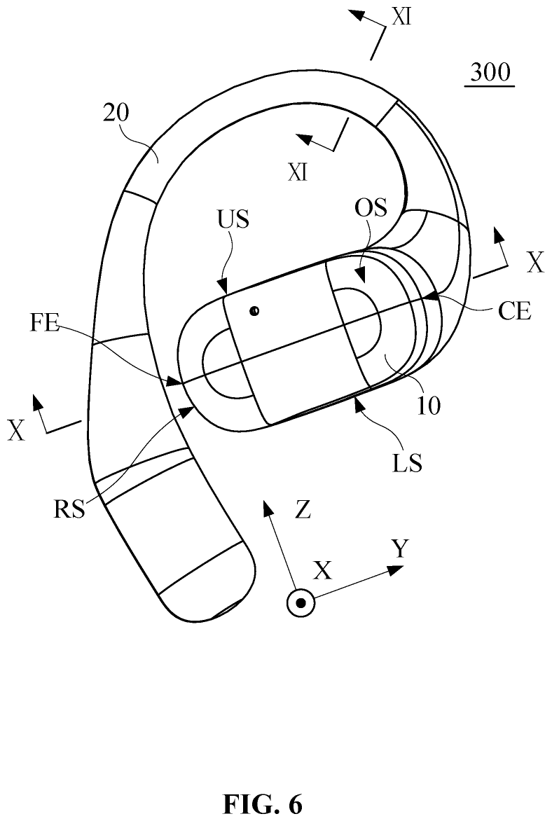

Referring to FIG. 5, FIG. 5 is a schematic diagram illustrating an exemplary anterior side profile of an ear of a user or a simulator according to some embodiments of the present disclosure. An ear 200 of a user may include physiological parts, such as an external ear canal 201, a cavum conchae 202, a cymba conchae 203, a triangular fossa 204, an antihelix 205, a scaphoid fossa 206, a helix 207, a tragus 208, etc.

The external ear canal 201 has a certain depth and extends to an eardrum of the ear. For the convenience of description, unless otherwise specified, the external ear canal 201 refers to an entrance (i.e., an ear hole) of the external ear canal 201 that is away from the tympanic membrane in the present disclosure. Further, the physiological parts (e.g., the cavum conchae 202, the cymba conchae 203, the triangular fossa 204, etc.) have a certain volume and depth. The cavum conchae 202 is directly connected to the external ear canal 201, which can be simply regarded as that the aperture is located at a bottom of the cavum conchae 202.

It may be understood that different users may have individual differences, resulting in different dimensional differences (e.g., different shapes, sizes, etc.) of the ear 200. For the convenience of description and to reduce (or even eliminate) the individual differences between the users, a simulator including a head and (left and right) ears of the head may be produced based on the ANSI: S3.36, S3.25 and IEC: 60318-7 standards, such as a GRAS 45BC KEMAR, a HEAD Acoustics system, a B&K 4128 series, or a B&K 5128 series, so as to present a wearing scenario of the earphone 10 by a majority of the users. Merely by way of example, taking a GRAS KEMAR as an example, the simulator of the ear may be any one of a GRAS 45AC, a GRAS 45BC, a GRAS 45CC, or a GRAS 43AG. As another example, taking the HEAD Acoustics as an example, the simulator of the ear may be any one of HMS II.3, HMS II.3 LN, or HMS II.3LN HEC.

It should be noted that in fields of medicine, anatomy, etc., three basic sections (a sagittal plane, a coronal plane, and a horizontal plane) and three basic axes (a sagittal axis, a coronal axis, and a vertical axis) of a human body may be defined. The sagittal plane refers to a section along an anterior-posterior direction of the body and perpendicular to the ground, which divides the body into left and right parts. The coronal plane refers to a section along a left-right direction of the body and perpendicular to the ground, which divides the body into anterior and posterior parts. The horizontal plane refers to a section along an up-down direction of the body and parallel to the ground, which divides the body into upper and lower parts. Correspondingly, the sagittal axis refers to an axis along the anterior-posterior direction of the body and perpendicular to the coronal plane, the coronal axis refers to an axis along the left-right direction of the body and perpendicular to the sagittal plane, and the vertical axis VA refers to an axis along the upper-lower direction of the body and perpendicular to the horizontal plane. Furthermore, an “anterior side of the ear 200” described in the present disclosure is a concept relative to a “posterior side of the ear 200”, the anterior side refers to a side of the ear 200 away from the head, and the posterior side refers to a side of the ear 200 toward the head, and the anterior side and the posterior side are defined with respect to the ear 200 of the user. When observing the ear of the simulator along a direction at which the coronal axis of the human body is located, a schematic diagram of an anterior side profile of the ear 200 shown in FIG. 5 may be obtained.

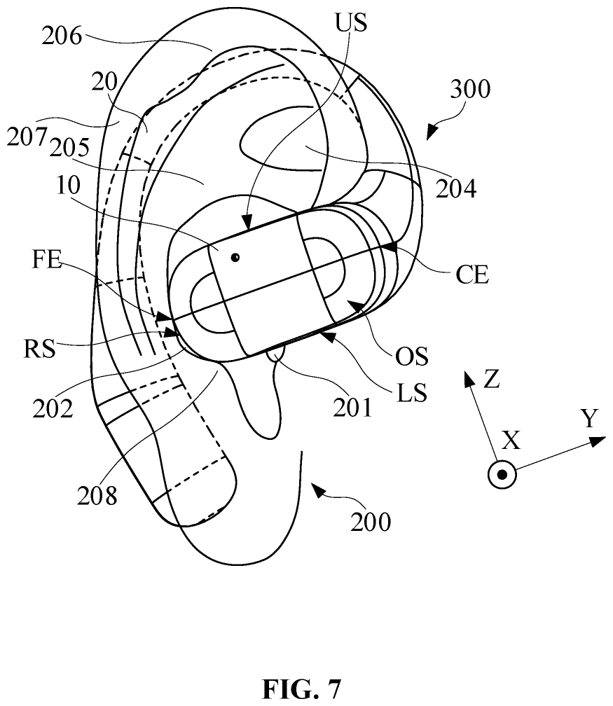

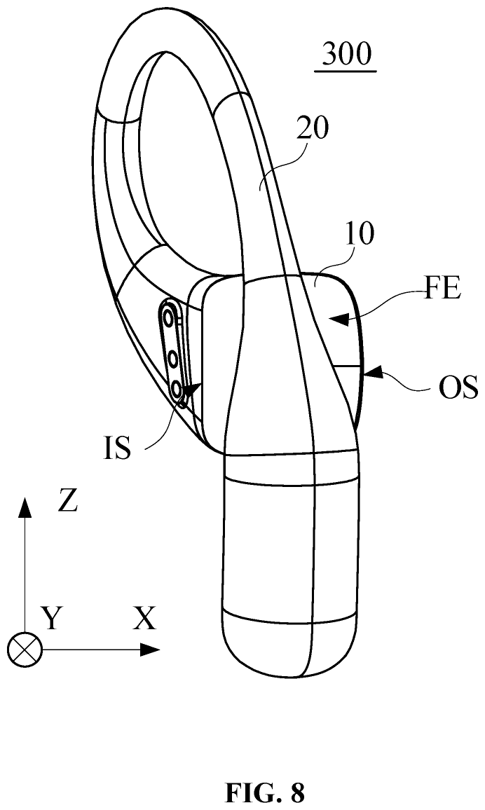

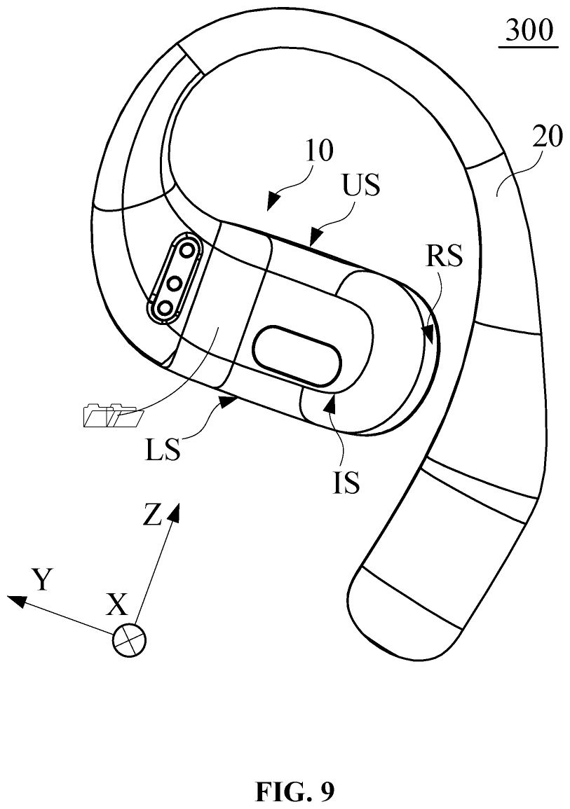

Referring to FIG. 6, FIG. 7, FIG. 8, and FIG. 9, FIG. 6 is a schematic diagram illustrating an exemplary earphone 300 according to some embodiments of the present disclosure. FIG. 7 is a schematic diagram illustrating the earphone 300 shown in FIG. 6 in a wearing state according to some embodiments of the present disclosure. FIG. 8 is a schematic diagram illustrating a structure of the earphone 300 shown in FIG. 6 from another perspective according to some embodiments of the present disclosure. FIG. 9 is a schematic diagram illustrating a structure of the earphone 300 shown in FIG. 6 from still another perspective according to some embodiments of the present disclosure. An earphone 300 may include a core module 10 and an ear hook 20 connected to the core module 10. The core module 10 is located at the anterior side of the ear 200 in a wearing state. At least a portion of the ear hook 20 is located at the posterior side to the ear 200 in the wearing state, so that the earphone 300 is hung on the ear 200 in the wearing state.

In the present disclosure, descriptions such as “the user wears the earphone 300,” “the earphone 300 is in the wearing state,” “in the wearing state,” etc., may refer to that the earphone 300 described in the present disclosure is worn on the ear 200 of the simulator. Of course, due to the individual differences between different users, there may be certain differences when the earphone 300 is worn by different users and when the earphone 300 is worn on the ear 200 of the simulator, but the differences should be tolerated.

The core module 10 may have a connecting end CE connected to the ear hook 20 and a free end FE not connected to the ear hook 20. The core module 10 or the auxiliary structure connected to the core module 10 is configured such that at least a portion thereof extends into the physiological parts, such as the cavum conchae 202, the cymba conchae 203, the triangular fossa 204, the scaphoid fossa 206, etc. At least a portion of the ear hook 20 is configured as a contoured structure that contacts at least one of the posterior side of the ear 200 or the head, to increase a contact area between the ear hook 20 and the ear 200 and/or the head.

Referring to FIG. 7, in the wearing state, the free end FE of the core module 10 may extend into the cavum conchae 202. The free end FE may press against the cavum conchae 202 in a thickness direction X. Certainly, the free end FE may also abut against the cavum conchae 202 in a length direction Y and a width direction Z.

Referring to FIG. 7 and FIG. 8, the core module 10 may have an inner surface IS facing the ear 200 and an outer surface OS facing away from the ear 200 in the wearing state along the thickness direction X, and a connecting surface connecting the inner surface IS and the outer surface OS. The thickness direction X may be defined as a direction in which the core module 10 approaches or moves away from the ear 200 in the wearing state.

It should be noted that, in the wearing state and when observed along the direction of the coronal axis, the core module 10 may be configured in shapes, such as, a circle, an ellipse, a rounded square, a rounded rectangle, etc. When the core module 10 is configured in the shapes, such as, the circle, the ellipse, etc., the connecting surface may refer to an arc-shaped side surface of the core module 10. When the core module 10 is configured in shapes, such as, the rounded square, the rounded rectangle, etc., the connecting surface may include a lower surface LS, an upper surface US, and a rear surface RS, as shown in FIG. 6. The core module 10 may have the length direction Y and the width direction Z that are perpendicular to the thickness direction X and orthogonal to each other. The length direction Y may be defined as a direction in which the core module 10 approaches or moves away from the back of the head in the wearing state. The width direction Z may be defined as a direction in which the core module 10 approaches or moves away from the top of the head in the wearing state. Therefore, for ease of description, the core module 10 configured as the rounded rectangle is taken as an example for illustrative explanation in the embodiment. In some embodiments, a length of the core module 10 in the length direction Y may be greater than a width of the core module 10 in the width direction Z.

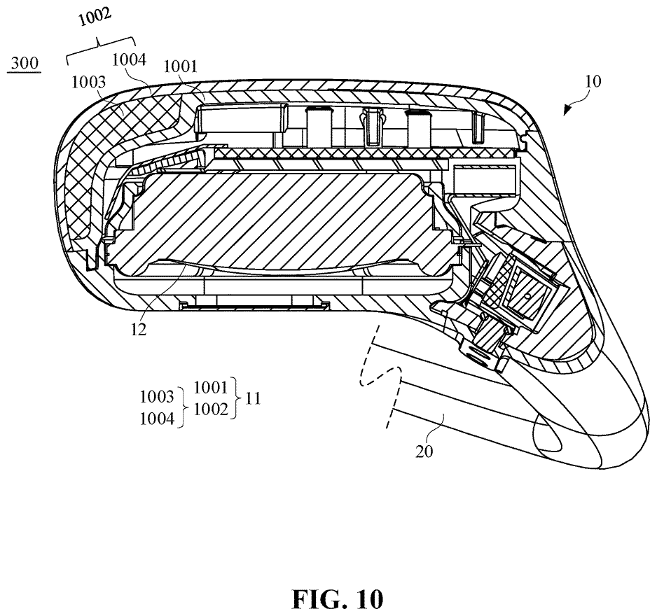

Referring to FIG. 10, FIG. 10 is a schematic diagram illustrating a cross-sectional view of the earphone 300 in FIG. 6 along a line X-X according to some embodiments of the present disclosure. The core module 10 may include a core housing 11 connected to the ear hook 20 and a speaker 12 disposed within the core housing 11. The core housing 11 may adopt the housing 100 from the above embodiments. The speaker 12 is a structure for realizing a main function of the earphone 300.

In some embodiments, the silicone coating layer 1002 is disposed corresponding to at least a portion of the free end. In FIG. 10, the first silicone coating layer 1003 may be at least partially sandwiched between the inner housing 1001 and the second silicone coating layer 1004. The first silicone coating layer 1003 may be disposed in a region corresponding to the free end FE as much as possible. In some embodiments, the first silicone coating layer 1003 may be formed on a preset region of the inner housing 1001. In some embodiments, the first silicone coating layer 1003 may at least partially cover a region of the inner housing 1001 corresponding to the free end FE, so that the core module 10 at least partially abuts against the cavum conchae 202 via the first silicone coating layer 1003. In other words, a portion of the inner housing 1001 that extends into the cavum conchae 202 and contacts the cavum conchae 202 may be covered by the first silicone coating layer 1003, thereby improving the comfort of the earphone 300 in the wearing state.

In some embodiments, the first silicone coating layer 1003 may continuously cover at least a portion of the region of the inner housing 1001 corresponding to the rear surface RS, the upper surface US, and the lower surface LS.

The second silicone coating layer 1004 may be formed on the preset region of the inner housing 1001 and/or the first silicone coating layer 1003.

In some embodiments, under the control of the thickness of the first silicone coating layer 1003, the silicone coating layer 1002 at the free end FE may generate a compression amount in a range of 0.4 mm to 2 mm when subjected to a pressure of 0.5 MPa. When the free end FE of the core module 10 extends into the cavum conchae 202, the silicone coating layer 1002 can contact with the irregular surface of the cavum conchae 202, and the compression amount of 0.4 mm to 2 mm can make the silicone coating layer 1002 better fit the irregular surface of the cavum conchae 202, thereby increasing the contact area, and improving the user's wearing comfort.

In some embodiments, under the control of the thickness of the first silicone coating layer 1003, an outer surface of the silicone coating layer 1002 at a portion of the free end FE farthest from the connecting end CE produces a compression amount in a range of 0.4 mm to 2 mm under a pressure of 0.5 MPa applied along a separation direction between the free end FE and the connecting end CE.

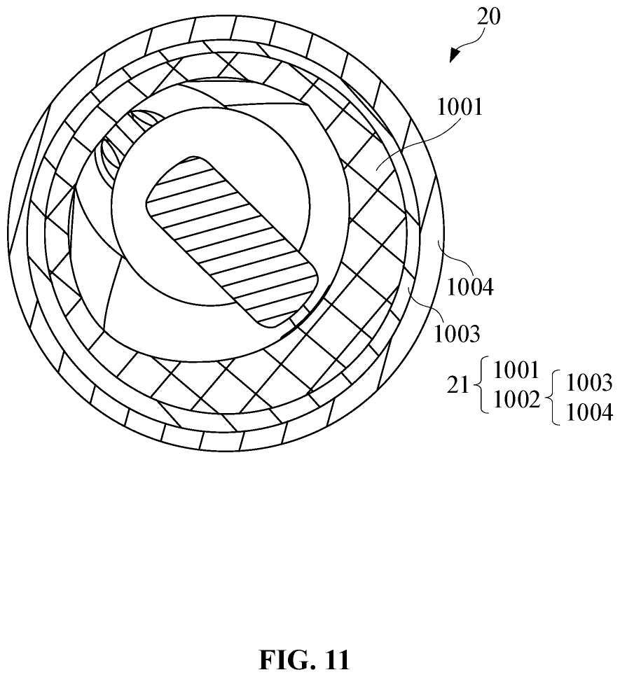

Referring to FIG. 11, FIG. 11 is a schematic diagram illustrating a cross-sectional view of the ear hook 20 in FIG. 6 along a line XI-XI according to some embodiments of the present disclosure. The ear hook 20 may include a wearing housing 21. The wearing housing 21 may adopt the housing 100 in the above embodiments to improve the wearing comfort.

In the several implementation manners provided in the present disclosure, it should be understood that the disclosed manners and device may be implemented in other manners. As an example, the device implementation manners described above are merely illustrative. For example, the division of modules or units is merely a division based on logical functions. In actual implementation, there may be other division manners. For example, a plurality of units or components may be combined or integrated into another system, or some features may be omitted or not executed.

The units described as separate components may or may not be physically separate. The components displayed as units may or may not be physical units, i.e., they may be located in one place or distributed across a plurality of network units. Some or all of the units may be selected according to actual needs to achieve the objectives of the solutions of the present implementation manner.

In addition, the functional units in the various implementation manners of the present disclosure may be integrated into one processing unit, or each unit may exist alone physically, or two or more units may be integrated into one unit. The above integrated unit may be implemented in the form of hardware or in the form of a software functional unit.

The foregoing descriptions are merely specific implementation manners of the present disclosure, but are not intended to limit the scope of the patent of the present disclosure. Any equivalent structure or equivalent process transformation made by using the content of the specification and drawings of the present disclosure, or directly or indirectly applied in other related technical fields, shall similarly fall within the patent protection scope of the present disclosure.

1. A housing, comprising:
an inner housing; and
a silicone coating layer disposed on at least a portion of an outer surface of the inner housing, wherein
the silicone coating layer includes a first silicone coating layer and a second silicone coating layer sequentially stacked on the outer surface of the inner housing,
the first silicone coating layer is bonded to the outer surface of the inner housing,
the second silicone coating layer covers a side of the first silicone coating layer away from the inner housing,
a hardness of the second silicone coating layer is greater than a hardness of the first silicone coating layer,
a compressive modulus of the first silicone coating layer is within a range of 0.01 megapascal (MPa) to 0.1 MPa; and
a bonding strength between the first silicone coating layer and the inner housing is not less than 0.005 MPa.

2. The housing of claim 1, wherein the compressive modulus of the first silicone coating layer is not larger than 0.06 MPa.

3. The housing of claim 1, wherein an interior of the first silicone coating layer has a honeycomb structure.

4. The housing of claim 1, wherein a thickness of the first silicone coating layer is larger than a thickness of the second silicone coating layer.

5. The housing of claim 1, wherein in the at least portion of the outer surface, an overall thickness of the silicone coating layer is within a range of 0.5 millimeters (mm) to 2.5 mm.

6. The housing of claim 5, wherein the thickness of the first silicone coating layer is configured such that the at least portion of the outer surface of the silicone coating layer produces a compression amount within a range of 0.4 mm to 2 mm under a pressure of 0.5 MPa.

7. The housing of claim 1, wherein the compressive modulus of the first silicone coating layer is measured when a strain amount of the first silicone coating layer is within a range of 5% to 10%.

8. The housing of claim 1, wherein a roughness of a bonding region of the outer surface of the inner housing for bonding the first silicone coating layer is greater than a roughness of at least a portion of other regions of the outer surface of the inner housing.

9. The housing of claim 8, wherein the roughness of the bonding region is within a range of 10 micrometers to 200 micrometers.

10. An earphone, comprising:
an ear hook; and
the housing according claim 1, wherein
the housing has a connecting end connected to the ear hook and a free end not connected to the ear hook, and
the silicone coating layer is disposed on at least a portion of the free end.

11. The earphone of claim 10, wherein
the housing is located on an anterior side to an ear in a wearing state;
the free end extends into a cavum conchae of the ear; and
a thickness of the first silicone coating layer is configured such that a portion of the outer surface of the silicone coating layer at a position of the free end farthest away from the connecting end produces a compression amount within a range of 0.4 mm to 2 mm under a pressure of 0.5 MPa along a separation direction between the free end and the connecting end.

12. The housing of claim 1, wherein the compressive modulus of the first silicone coating layer is not larger than 0.04 MPa.

13. The housing of claim 1, wherein the hardness of the second silicone coating layer is less than a hardness of the inner housing.

14. The housing of claim 1, wherein an interior of the first silicone coating layer has a column array structure.

15. The earphone of claim 10, wherein an interior of the first silicone coating layer has a honeycomb structure.

16. The earphone of claim 10, wherein an interior of the first silicone coating layer has a column array structure.

17. The earphone of claim 10, wherein the thickness of the first silicone coating layer is configured such that the at least portion of the outer surface of the silicone coating layer produces a compression amount within a range of 0.4 mm to 2 mm under a pressure of 0.5 MPa.

18. The earphone of claim 10, wherein the compressive modulus of the first silicone coating layer is measured when a strain amount of the first silicone coating layer is within a range of 5% to 10%.

19. The earphone of claim 10, wherein a roughness of a bonding region of the outer surface of the inner housing for bonding the first silicone coating layer is greater than a roughness of at least a portion of other regions of the outer surface of the inner housing.

20. The earphone of claim 19, wherein the roughness of the bonding region is within a range of 10 micrometers to 200 micrometers.
